(19) United States
(12) Patent Application Publication
(10) Pub. No.: US 2008/0317091 A1
(43) Pub. Date: Dec. 25, 2008

(54) Scale Detection on Water Heating Elements

(75) Inventor: Jeremy Siddons, Derbyshire (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: OTTER CONTROLS LIMITED, DERBYSHIRE (GB)

(21) Appl. No.: 11/997,518

(22) PCT Filed: Jul. 20, 2006
(86) PCT No.: PCT/GB2006/002722

§ 371 Date: Jul. 15, 2008

(30) Foreign Application Priority Data
Aug. 11, 2005 (GB) 0516520.4

(51) Int. Cl. G05D 23/24

(52) U.S. Cl. 374/102; 219/506; 219/438

(57) ABSTRACT

A method of determining the presence of scale on a water heating element (12), the method comprising comparing signals indicative of heating element temperature to determine whether the compared signals indicate a temperature decrease (44) greater than a predetermined value during a predetermined time interval and determining the presence of scale if the indicated temperature decrease is greater than said predetermined value.

### BACKGROUND TO THE INVENTION

The invention relates to the detection of scale on water heating elements and particularly, but not exclusively, to the detection of scale on the heating elements of water boiling vessels, such as kettles.

It is known that where a heating element contacts water, unless the element is coated with a material that prevents scale forming and/or the water is filtered, scale will tend to form on the element. This is particularly the case in areas where the water supplied is so-called hard water; i.e. water containing low percentages of calcium and magnesium carbonates, bicarbonates, sulphates or chlorides due to long contact with rocky substrates.

When scale forms on a heating element, it makes the element less efficient as a heater and may result in permanent damage to the heating element.

One conventional scale detection method relies on measuring the actual running temperature of the heating element during or at boiling and comparing this temperature with some set value that is higher than the temperature at which the element runs when it is new. If the heating element reaches the set value during boiling, it indicates that scale has formed on the element and a suitable indication is provided to the user. Typically, a bimetal sensor is used to detect boiling and the measured temperature that is used to determine whether scale has formed is taken when the bimetal sensor switches. The problem with this method is that, if a cheap bimetal sensor is used, setting tolerances mean that some appliances will indicate the need for descaling prematurely. This leads the user to disregard the warning. Conversely in some appliances the indication will be too late, which means that the element may be run too hot until such time as the indication is finally given. The end result of either situation is that excessive scale may build up, causing the heating element to overheat. This shortens the life of the heating element. A further disadvantage of this approach is that it is very difficult to discriminate between scale build-up and operation of the appliance without any water, since both result in a high sensed temperature which will trigger the scale warning.

An alternative known method uses an electronic temperature sensor, for example, an NTC thermistor. The thermistor is calibrated to some known temperature and then used to determine an absolute running temperature at which the degree of scaling is considered sufficient to require removal. When this temperature is sensed during operation of the kettle, an indication is given that descaling is required. One method of calibration is to use the boiling point of the first use (or first several uses) of the appliance, at which time the element is considered to be clear of scale. A system similar to this is disclosed in GB 2 358 971. One problem with this approach is that there is only a single opportunity for calibrating the sensor. After that any changes in any of the components will lead to drift of the indicated temperature, or the running temperature of the heating element. Also a calibrating system, which is only used once, needs to be provided in the control software. This adds complication that may cause subsequent reliability problems.

Another system for indicating scale build-up is disclosed in GB 2 228 634. The absolute element running temperature of the heating element is compared with a predetermined value. A temperature in excess of that value indicates the presence of scale. The sensor used requires some calibration to achieve accurate results.

### SUMMARY OF THE INVENTION

The invention provides a method of determining the presence of scale on a water heating element, the method comprising comparing signals indicative of heating element temperature to determine whether the compared signals indicate a temperature decrease greater than a predetermined value during a predetermined time interval and determining the presence of scale if the indicated temperature decrease is greater than said predetermined value.

### BRIEF DESCRIPTION OF THE DRAWINGS

In order that the invention may be well understood, some embodiments thereof, which are given by way of example only, will now be described, with reference to the drawings, in which:

FIG. 1 is a perspective view of an underfloor heating element for a water boiling vessel fitted with a temperature sensor of a scale detection system;

FIG. 2 is a representation of a circuit of a control system of the scale detection system;

FIG. 3 is a graphical representation of the output of the control system when there is no scale on the heating element; and

FIG. 4 is a graphical representation of the output of the control system when there is a build-up of scale on the heating element.

### DETAILED DESCRIPTION OF THE EMBODIMENTS

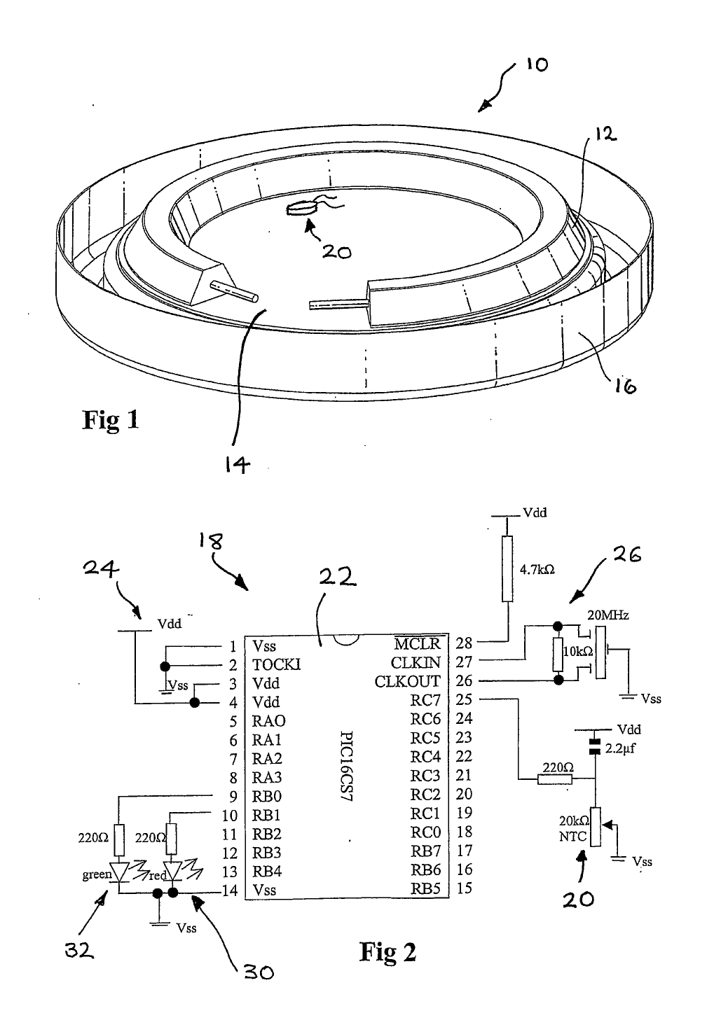

FIG. 1 is a perspective view of the underside of an underfloor heating element 10 for a water boiling vessel, such as a kettle. The embodiment will be described as used in a kettle. However, this is not to be taken as limiting.

The underfloor heating element 10 comprises a sheathed electrical heating element 12 secured to an element heat dispersion plate 14, which would typically be made of aluminum. The heating element 12 is secured to the heat dispersion plate 14 in any conventional way, such as by clenching, clamping, welding or soldering. Sheathed electrical heating elements are well-known to those skilled in the art and typically comprise a resistance heating wire housed in an elongate sheath packed with a mineral insulating material.

The element dispersion plate 14 is secured to a stainless steel member 16 that is shaped to form the floor of the water containing chamber of a water boiling vessel, such as a kettle. As will be well-known to those skilled in the art, the shape and configuration of the stainless steel member 16 can be varied considerably to suit the body of the kettle into which the underfloor heating element is to be incorporated. In use, scale will tend to form on the surface (not shown) of the stainless steel member 16 that is in contact with the water in the water-containing chamber of the kettle.

Referring to FIG. 2, a system 18 for detecting the presence of scale on the underfloor heating element 10 comprises a temperature sensor in the form of an NTC thermistor 20. As shown in FIG. 1, the thermistor 20 is secured to the heat dispersion plate 14 adjacent the heating element 12. The thermistor 20 can be secured to the heat dispersion plate 14 in any convenient manner. For example, it may be provided in a mounting clipped to the heat dispersion plate 14 or it may be secured to the plate using a clamp or suitable adhesive. All that is necessary is that the thermistor 20 is exposed to the heat of the heat dispersion plate 14 in such a way that it can produce output signals indicative of the temperature of the heat dispersion plate and, so, the temperature of the heating element 12.

The system 18 further comprises an integrated circuit (chip) 22, which is connected to the thermistor 20 such that it can receive signals from the thermistor 20. The chip 22 is additionally connected to a suitable power supply 24 and a quartz crystal oscillator (timing chip) 26. The chip 20 is further connected with a display 28 comprising a red LED 30 and a green LED 32.

The chip 20 is programmed to read signals from the thermistor 20 at each time interval determined by the timing chip 26. If the signal indicates that the temperature of the heating element 12 is rising, it is ignored. If the signal indicates a falling temperature, it is compared against a threshold. If the chip 22 determines that during a predetermined time interval there is a fall in temperature greater than the threshold value, this is taken as an indication of the presence of scale and a signal is provided to cause the red LED 30 to light. In this way, the user is provided with a simple indication that the underfloor heating element 10 requires descaling. If the signals from the thermistor 20 are such as to indicate that descaling is not required, the green LED 32 remains lit to convey that information to the user.

The system 18 relies on the fact that when the heating element 12 is switched off after heating the water, the surface temperature of the underfloor heating element (i.e. the temperature of the surface of the stainless steel member 16 that is in contact with the water) will always rapidly return to a temperature close to the water temperature, regardless of the amount of scale on the surface of the stainless steel member 16. This is because scale is porous and, consequently, saturates rapidly with water. This water rapidly settles to the bulk water temperature, any excess heat being discharged by the latent heat of evaporation. Since the heat dispersion plate 14 is in intimate contact with the stainless steel member 16 to provide good heat transfer between the heating element 12 and the water in the water-containing chamber of the kettle, this rapid fall in temperature is sensed by the thermistor 20.

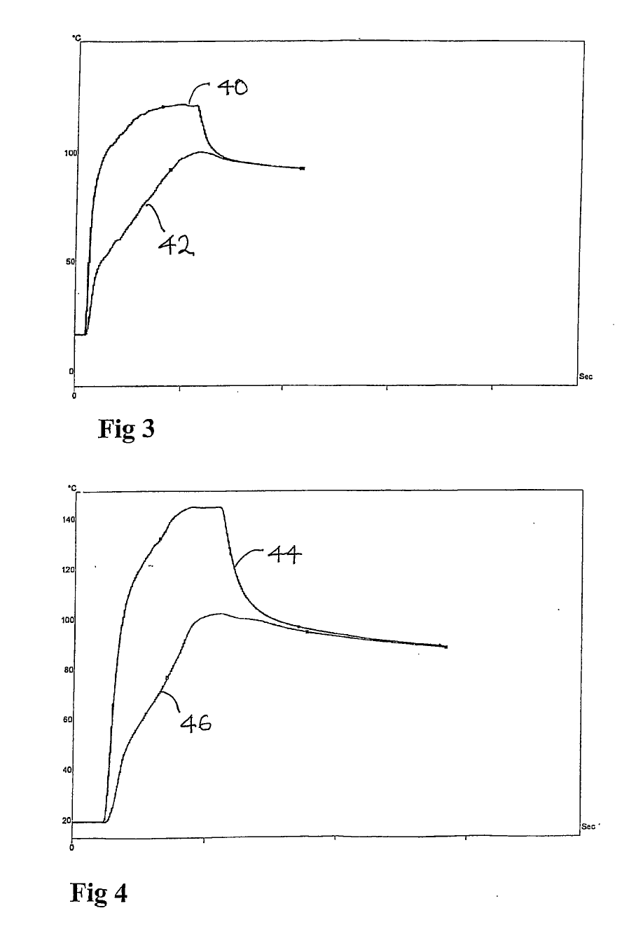

The way in which the system 18 utilises the fall in temperature detected by the thermistor 20 will be further explained with reference to FIGS. 3 and 4.

FIG. 3 is a graphical representation of the output of the thermistor 20 when placed at two different locations on the heat dispersion plate 14 of an underfloor heating element 10 on which there is no, or very little scale. The trace 40 represents the output of the thermistor 20 when placed close to the heating element 12. The trace 42 represents the output of the thermistor 20 when placed further away from the heating element.

FIG. 4 is a graphical representation of the output of the thermistor 20 when there is a significant build-up of scale on the underfloor heating element 10 and descaling is required. The trace 44 represents the output of the thermistor 20 when placed at the position that produced the trace 40 and the trace 46 represents the output of the thermistor when placed at the position that produced the trace 42.

The trace 40 shows the detected temperature as rising to about 123° C. at which point the kettle's boil control has caused power to the heating element 12 to be turned off. The temperature detected by the thermistor 20 then falls rapidly to 100° C. Thereafter, the trace continues to fall slowly, reflecting the cooling of the water in the kettle.

The trace 44 shows the detected temperature as rising to about 147° C. at which point the boil control has caused the power to the heating element to be turned off. As with the trace 40, once the heating element 12 is de-energised, the detected temperature falls rapidly to 100° C. Comparing the two traces 40 and 44, it will be appreciated that there is an initially steep fall in temperature of similar duration that is significantly greater in the case where there is a significant build-up of scale on the underfloor heating element, as represented by trace 44, as against when there is no, or very little, scale, as represented by trace 40. Therefore, by determining a suitable time interval and a temperature drop value for that time interval that is to be taken as indicating the presence of scale (these being figures readily determined by simple experimentation), it is possible to configure the system 18 such that it can determine scale build-up by simply comparing signals from the thermistor 12 and checking to see whether they indicate a temperature decrease during the time interval that is greater than the predetermined temperature drop value. If it is, the system 18 determines that there is a build-up of scale requiring that the kettle is descaled and, if it is not, the system determines that there is no scale, or there is insufficient scale to require descaling.

It will be appreciated that since the system 18 simply compares temperature indicating signals to determine a difference between them and does not rely on determining the actual temperature of the heating element 12, scaling can be detected without calibration of the temperature sensor and regardless of any drift in the absolute value of any of the system components. This avoids some of the problems encountered with conventional systems.

The traces 42 and 46 show the output of the thermistor 20 if it is sited too far away from the heating element 12. It will be appreciated that the drop in temperature from the peak temperature to a steady state temperature is rather small and using this output from the thermistor would not produce satisfactory results. From this, it will be understood that to produce the required magnitude of temperature change, and thus achieve the necessary sensitivity, the thermistor 20 can simply be moved towards or away from the heating element 12.

The chip 22 may be programmed such that at each time interval determined by the timing chip 26, it compares the last received signal from the thermistor with the immediately preceding signal. When the difference between the two signals indicates a temperature rise, the result is disregarded. If the comparison indicates a temperature decrease, the decrease is compared with the predetermined temperature drop value to determine the presence of scale. In this arrangement, it would not be necessary for the system 18 to know whether the heating element 12 is energised and the signals from the thermistor 20 used for the comparison could both be received subsequent to the heating element being de-energised. Thus, both signals would be received during the initial steep cooling portions of the traces 40, 44.

In an alternative arrangement, the chip 22 could be provided with signals that would allow it to determine that the heating element 12 has just been de-energised following a heating operation. In this case, on determining that the heating element 12 has just been de-energised, the chip 22 would compare the last signal received from the thermistor prior to the heating element being de-energised with a signal received subsequent to the heating element being de-energised. For this purpose, the chip 22 could receive signals from a power supply control that incorporates a steam control. Steam controls are devices well known to those skilled in the art of kettle design and manufacture and, so, will not be described in detail herein. Essentially, a steam control is arranged to be exposed to steam generated when water in the kettle boils and causes the power supply control to de-energise the heating element when it detects boiling. It will be appreciated that the power supply control would not necessarily comprise a steam control and could, instead, comprise suitable means for causing it to de-energise the heating element at a predetermined temperature lower than boiling.

Although it is preferred to use a simple control strategy in which a successive pair of signals from the thermistor is compared, this is not essential. If desired, a first received signal could first be compared with the next received signal and then subsequently compared with a succeeding received signal.

The control system 18 has been described in use to detect scale forming on an underfloor heating element comprising a sheathed electric heating element. However, the control system 18, or a variation thereof, could be used to detect the presence of scale on underfloor heating elements comprising a thick film heater. In that case, the temperature sensor could be printed onto the substrate of the thick film heater in the same way as the heater tracks, so eliminating the need for a separate component. The control system 18, or a variation thereof, could also be used to detect scale build-up on an immersed heating element. All that would be required is the positioning of the temperature sensor at a location at which the output of the sensor reflected the rise and fall in temperature of the heating element with a sufficient magnitude of temperature drop to provide the required sensitivity.

In the embodiment, the temperature sensor is an NTC thermistor. It will be appreciated that this is not essential and any suitable form of temperature sensor may be employed.

In the embodiment, the control system 18 is described and employed in use in a kettle, in which case, the underfloor heating element 10 is typically used to bring the water temperature up to boiling, at which point the heating element 12 is de-energised. The fall in temperature used to determine the presence in scale is detected subsequent to that. However, as previously indicated, the invention is not limited to applications in which the water is boiled. The invention might, for example, be used in a device for raising the temperature of water to a temperature below boiling, for example, to 80° C. All that is necessary is to have a falling temperature gradient sufficient to provide differences that can be compared to provide a determination of the presence of scale.

In the embodiment, the falling temperature occurs after the power to the heating element is turned off. However, in principle, this is not essential, provided there is a temperature decrease of sufficient magnitude to allow a determination to be made.

The invention is primarily directed to scale detection in water heating appliances such as kettles and jugs. However, in principle, it could be applied to other water heating equipment, such as a water heater of an electric shower unit or an immersion heater used to provide a domestic hot water supply.

1. A method of determining the presence of scale on a water heating element, the method comprising comparing signals indicative of heating element temperature to determine whether the compared signals indicate a temperature decrease greater than a predetermined value during a predetermined time interval and determining the presence of scale if the indicated temperature decrease is greater than said predetermined value.

2. A method as claimed in claim 1, wherein a first of said compared signals is obtained while the heating element is energised.

3. A method as claimed in claim 2, wherein said first signal is obtained while water heated by the heating element is boiling.

4. A method as claimed in claim 2 or 3, wherein a second of said compared signals is obtained subsequent to said heating element being de-energised.

5. A method as claimed in claim 4, wherein said heating element is de-energised in response to boiling of said water.

6. A computer program product comprising one or more software portions which, when executed in an execution environment, are operable to implement one or more of the steps of any one preceding claim.

7. An integrated circuit having at least one software portion of claim 6 stored therein.

8. A system for detecting scale on a water heating element, said system comprising signal providing means for providing signals indicative of the temperature of a said heating element and signal comparing means for comparing signals received from said signal providing means and determining whether the compared signals indicate a temperature decrease greater than a predetermined value during a predetermined time interval, the presence of scale being determined if a said temperature decrease is greater than said predetermined value.

9. A system as claimed in claim 8, further comprising means for detecting that said heating element has been de-energised following water heating operation, wherein said compared signals comprise at least one signal received when the heating element is energised and at least one signal received when said detecting means has detected that the heating element has been de-energised.

10. A system as claimed in claim 9, wherein said detecting means is adapted to detect that the heating element has been de-energised by receiving signals from a control means that controls the energy supply to the heating element.

11. A system as claimed in any one of claims 8 to 10, further comprising means for outputting a signal indicating the presence of scale.

12. A system as claimed in claim 10, further comprising illumination means operatively connected with said means for outputting a signal indicating the presence of scale and providing an illumination in response to a said signal.

13. A system as claimed in claim 8, wherein at least said signal comparing means is incorporated in an integrated circuit.

14. A system as claimed in claim 8, wherein said signal providing means comprises a temperature sensor for mounting in heat transfer relationship with said heating element.

15. A system as claimed in claim 7, in combination with an underfloor water heating element for a water heating appliance.

16. A system as claimed in claim 8, in combination with a water heating element comprising a thick film heater, wherein said signal providing means is incorporated in said thick film heater.

17. A water heating appliance comprising a heating element and a system for detecting the presence of scale on said heating element, said system comprising a temperature sensor in heat transfer relationship with said heating element for providing signals indicative of the temperature of said heating element and a processing device arranged to receive said signals, said processing device being arranged to determine the presence of scale on said heating element by comparing signals received from said signal providing means and determining whether the compared signals indicate a temperature decrease greater than a predetermined value during a predetermined time interval, the presence of scale being determined if a said temperature decrease is greater than said predetermined value.

18. An appliance as claimed in claim 17, wherein said processing device compares said signals when cooling of the heating element is determined, said processing device being arranged to receive signals from a power supply control that controls the supply of energy to said heating element and determine that said heating element is cooling when a signal from said power supply control indicates that said heating element has been de-energised following a period in which it has been energised.

19. An appliance as claimed in claim 18, wherein said power supply control incorporates a steam sensor for determining boiling of water heated by the appliance and said power supply controller is arranged to de-energise said heating element when a boiling condition is indicated.

20. An appliance as claimed in claim 17, 18 or 19, wherein one of said compared signals is received when the heating element is energised.

21. An appliance as claimed in claim 20, wherein said heating element is an underfloor heating element for a water heating appliance comprising a sheathed electrical heating element mounted to a plate member and said temperature sensor is mounted to said plate.

22. An appliance as claimed in claim 20, wherein said heating element comprises a thick film heater and said temperature sensor is integral with said thick film heater.

23. An appliance as claimed in claim 17, further comprising an illumination device, said processing device being operable to cause illumination of said device if the presence of scale is determined.

24. An appliance as claimed in claim 17, wherein said processing device comprises an integrated circuit.

25. (canceled)

26. (canceled)

27. (canceled)
